(19) United States
(12) Patent Application Publication
(10) Pub. No.: US 2007/0047477 A1
(43) Pub. Date: Mar. 1, 2007

(54) Extensible authentication protocol over local area network (EAPOL) proxy in a wireless network for node to node authentication

(75) Inventor: Heyun Zheng, Altamonte Springs, FL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(73) Assignee: MeshNetworks, Inc., Maitland, FL (US)

(21) Appl. No.: 11/209,981

(22) Filed: Aug. 23, 2005

(51) Int. Cl. H04Q 7/00

(52) U.S. Cl. 370/328; 455/411

(57) ABSTRACT

A system and method for providing an authentication protocol for authenticating nodes (102) for access to a network (100), such as to a server of a wireless ad-hoc peer-to-peer network (100). The wireless communication network (100), such as a mobile wireless distribution system (WDS), employs an extensible authentication protocol over LAN (EAPOL) proxy to authenticate nodes for access to the network via mobile or fixed access points (106).

### FIELD OF THE INVENTION

The present invention relates to a system and method for providing an authentication protocol for authenticating nodes for access to a network, such as to a server of a wireless ad-hoc peer-to-peer network. More particularly, the present invention relates to a wireless communication network, such as a mobile wireless distribution system (WDS), that employs an Extensible Authentication Protocol Over Local Area Network (EAPOL) proxy to authenticate nodes for access to the network.

### BACKGROUND

Wireless communication networks, such as mobile wireless telephone networks, have become increasingly prevalent over the past decade. These wireless communications networks are commonly referred to as “cellular networks”, because the network infrastructure is arranged to divide the service area into a plurality of regions called “cells”. A terrestrial cellular network includes a plurality of interconnected base stations, or base nodes, that are distributed geographically at designated locations throughout the service area. Each base node includes one or more transceivers that are capable of transmitting and receiving electromagnetic signals, such as radio frequency (RF) communications signals, to and from mobile user nodes, such as wireless telephones, located within the coverage area. The be appreciated by one skilled in the art, network nodes transmit and receive data packet communications in a multiplexed format, such as time-division multiple access (TDMA) format, code-division multiple access (CDMA) format, or frequency-division multiple access (FDMA) format, which enables a single transceiver at a first node to communicate simultaneously with several other nodes in its coverage area.

In recent years, a type of mobile communications network known as an “ad-hoc” network has been developed. In this type of network, each mobile node is capable of operating as a base station or router for the other mobile nodes, thus eliminating the need for a fixed infrastructure of base stations. More sophisticated ad-hoc networks are also being developed which, in addition to enabling mobile nodes to communicate with each other as in a conventional ad-hoc network, further enable the mobile nodes to access a fixed network and thus communicate with other mobile nodes, such as those on the public switched telephone network (PSTN), and on other networks such as the Internet. Details of these advanced types of ad-hoc networks are described in U.S. patent application Ser. No. 09/897,790 entitled “Ad Hoc Peer-to-Peer Mobile Radio Access System Interfaced to the PSTN and Cellular Networks”, filed on Jun. 29, 2001, in U.S. patent application Ser. No. 09/815,157 entitled “Time Division Protocol for an Ad-Hoc, Peer-to-Peer Radio Network Having Coordinating Channel Access to Shared Parallel Data Channels with Separate Reservation Channel”, filed on Mar. 22, 2001, now U.S. Pat. No. 6,817,165, and in U.S. patent application Ser. No. 09/815,164 entitled “Prioritized-Routing for an Ad-Hoc, Peer-to-Peer, Mobile Radio Access System”, filed on Mar. 22, 2001, now U.S. Pat. No. 6,873,839, the entire content of each being incorporated herein by reference.

As can be appreciated from the nature of wireless ad-hoc mobile networks, it is necessary for the network to be capable of recognizing whether a wireless more radio is authorized to access the network. Accordingly, a need exists for a process for authenticating radios or nodes for access to the wireless ad-hoc network.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a block diagram of an example ad-hoc wireless communications network including a plurality of nodes employing a system and method in accordance with an embodiment of the present invention;

FIG. 2 is a block diagram illustrating an example of a mobile node employed in the network shown in FIG. 1;

FIG. 3 is a conceptual block diagram illustrating the relationship between the Supplicant, Authenticator and Authentication Server in accordance with the Institute of Electrical & Electronic Engineers (IEEE) 802.1× Specification;

FIG. 4 is a conceptual diagram illustrating an example of the manner in which an authentication message transport is divided into two sections and transported over an 802.11 link layer 2 link and user datagram protocol (UDP) layer 3 link;

FIG. 5 is a conceptual block diagram illustrating an example of a modified authentication framework for wireless local area network (WLAN) with a meshed wireless distribution system (WDS); and

FIG. 6 is a diagram indicating an example of the exchange of information between devices that occurs during authentication according to an embodiment of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to an Extensible Authentication Protocol Over LAN (EAPOL) proxy in a wireless network for node to node authentication. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of an EAPOL proxy in a wireless network for node to node authentication described herein. The non-processor circuits may include, but are not limited to, a radio receiver, a radio transmitter, signal drivers, clock circuits, power source circuits, and user input devices. As such, these functions may be interpreted as steps of a method to perform operations to achieve an EAPOL proxy in a wireless network for node to node authentication. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

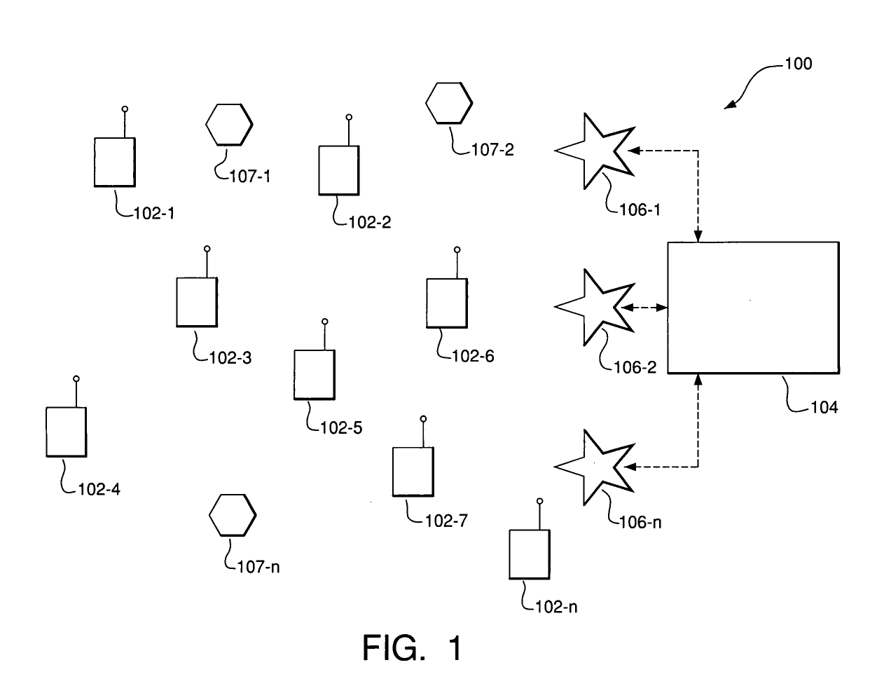

FIG. 1 is a block diagram illustrating an example of an ad-hoc packet-switched multi-hopping wireless communications network 100 employing an embodiment of the present invention. Specifically, the network 100 includes a plurality of mobile wireless user terminals 102-1 through 102-n (referred to generally as nodes 102 or mobile nodes 102), and can, but is not required to, include a fixed network 104 having a plurality of access points 106-1, 106-2, . . . 106-n (referred to generally as nodes 106 or access points 106), for providing nodes 102 with access to the fixed network 104. The fixed network 104 can include, for example, a core local access network (LAN), and a plurality of servers and gateway routers to provide network nodes with access to other networks, such as other ad-hoc networks, the public switched telephone network (PSTN) and the Internet. The network 100 further can include a plurality of fixed routers 107-1 through 107-n (referred to generally as nodes 107 or fixed routers 107) for routing data packets between other nodes 102, 106 or 107. It is noted that for purposes of this discussion, the nodes discussed above can be collectively referred to as “nodes 102, 106 and 107”, or simply “nodes”.

As can be appreciated by one skilled in the art, the nodes 102, 106 and 107 are capable of communicating with each other directly, or via one or more other nodes 102, 106 or 107 operating as a router or routers for packets being sent between nodes, as described in U.S. patent application Ser. No. 09/897,790 and U.S. Pat. Nos. 6,807,165 and 6,873,839, referenced above.

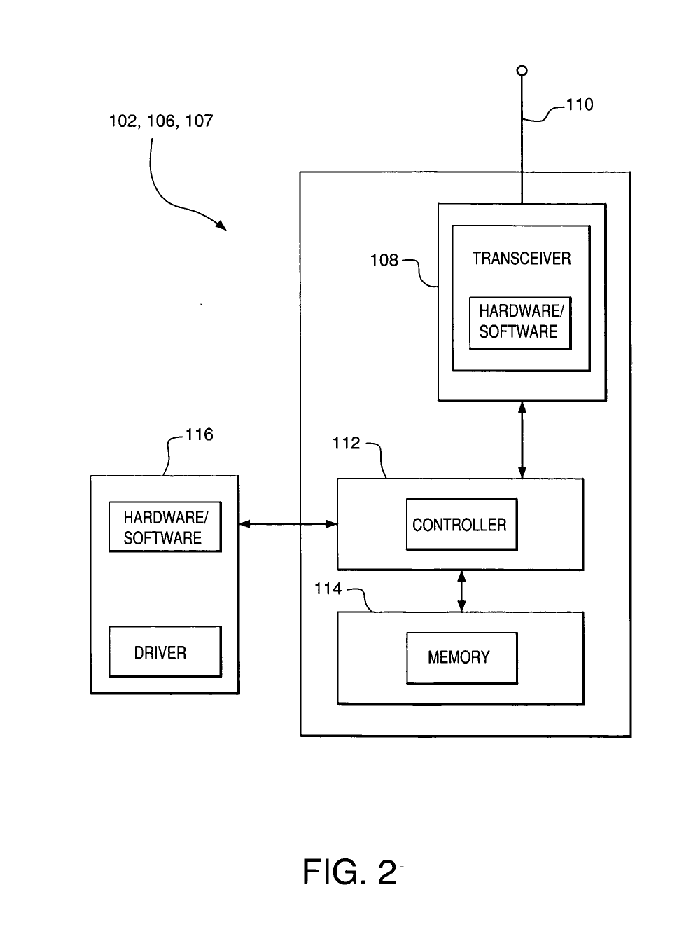

As shown in FIG. 2, each node 102, 106 and 107 includes a transceiver, or modem 108, which is coupled to an antenna 110 and is capable of receiving and transmitting signals, such as packetized signals, to and from the node 102, 106 or 107, under the control of a controller 112. The packetized data signals can include, for example, voice, data or multimedia information, and packetized control signals, including node update information.

Each node 102, 106 and 107 further includes a memory 114, such as a random access memory (RAM) that is capable of storing, among other things, routing information pertaining to itself and other nodes in the network 100. As further shown in FIG. 2, certain nodes, especially mobile nodes 102, can include a host 116 which may consist of any number of devices, such as a notebook computer terminal, mobile telephone unit, mobile data unit, or any other suitable device. Each node 102, 106 and 107 also includes the appropriate hardware and software to perform Internet Protocol (IP) and Address Resolution Protocol (ARP), the purposes of which can be readily appreciated by one skilled in the art. The appropriate hardware and software to perform transmission control protocol (TCP) and user datagram protocol (UDP) may also be included.

As will now be discussed, the present invention provides a system and method for providing an authentication protocol for authenticating nodes for access to a network, such as a server of a wireless ad-hoc peer-to-peer network. The system and method enables a wireless communication network, such as a mobile wireless distribution system (WDS), that employs an extensible authentication protocol over LAN (EAPOL) proxy to authenticate nodes for access to the network via mobile or stationary access points.

Specifically, the present invention provides a system and method for authenticating a node for access to a wireless communication network, such as an ad-hoc peer-to-peer wireless communication network, with the wireless communication network including a wired network and a wired access point that is wired to the wired network and enables communication between the wired network and wireless nodes. The system and method employ the operations of establishing the wired access point as an authenticator that is adapted to authenticate wireless node in the network, controlling the wireless node to send authentication information to the authenticator wired access point when the wireless node attempts to access the network, and controlling the authenticator wired access point to determine whether the authentication information is valid to permit access to the network by the wireless node when the authenticator wired access point receives the authentication information. The wireless node can be a mobile wireless node or itself a wireless access point that can be stationary or mobile.

As can be appreciated by one skilled in the art, the IEEE 802.1x specification describes an authentication framework for 802 based LANs. Details of these authentication frameworks can be found in the IEEE 802.1X specification, 2001 (EAPOL & 802.1X) and in RFC 2284: PPP Extensible Authentication Protocol (EAP), March 1998, for example, the contents of both of these documents are incorporated herein by reference. As discussed in more detail below, when used in wireless LANs, wireless Access Points (AP) can authenticate wireless users or stations with a backend Remote Authentication Dial-In User Service (RADIUS) Authentication Server. The user's credentials, such as user id and password, are stored in advance in the RADIUS Authentication Server, and are established in advance either by system administrator or user self-registration via some other communication channels. For example, when a user activates for the first time, the user can be prompted to answer a series of questions via a different medium, such as a secured web site or telephone line, to activate his or her unit. Also, each unit may have a serial number or other identifier that the network can recognize based on the network's security policy. At the very basic level, as long as the user id and password typed in by the user are the same as the pre-configured user id and password in RADIUS server, the network will allow access to that user's node.

When a wireless user then subsequently wants to access the network and, in particular, the wired network resource, the user will exchange messages with the wireless Access Point, which in turn will relay the message between the wireless user and the RADIUS Authentication Server. The exchange between the user and the wireless Access Point can be direct if they are within broadcast range of each other, or via other intermediate nodes as discussed above with regard to FIG. 1. The RADIUS Authentication Server will make the decision whether the access request is granted or denied and pass the decision to the wireless Access Point. The message exchange will depend on the authentication protocol used between the wireless user and the Authentication Server. Multiple authentication protocols can be utilized over Extensible Authentication Protocol (EAP).

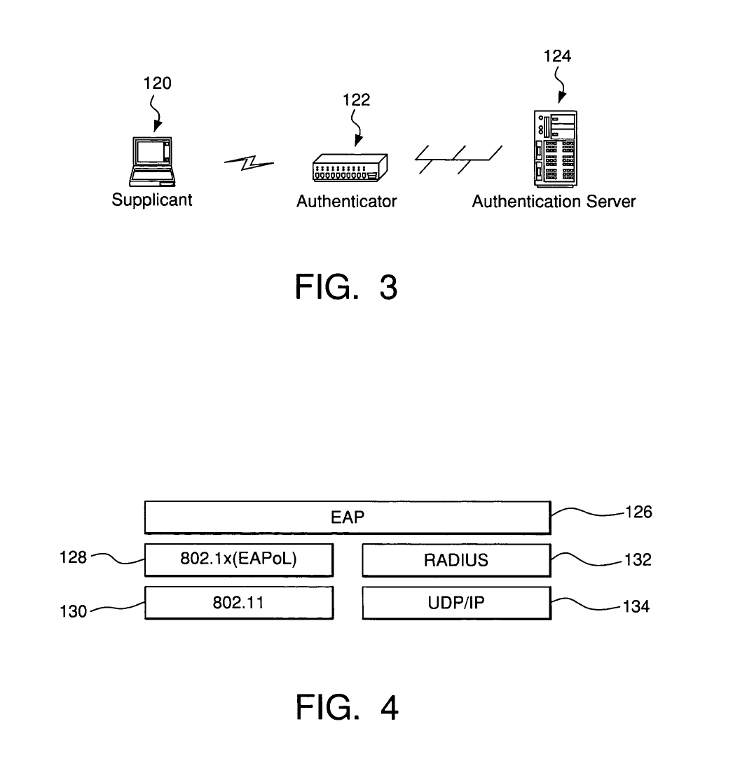

Three components are identified in the 802.1x framework: Supplicant, Authenticator and Authentication Server, which are shown in FIG. 3. As discussed above, user device, such as a node 102 shown in FIG. 1, which wishes to access the network 100 takes the role of a Supplicant 120, and a network access point (IAP) 106 will take the role of a Authenticator 122. RADIUS Authentication Server (AS) 124, which is generally located in a central and secure environment such as in the core LAN 104, provides authentication services to the authenticator. In a wireless LAN (WLAN) arrangement, the authentication message transport EAP 126 is divided into two sections: transport 1) EAPOL messages 128 over 802.11 link 130 (layer 2 link), and transport 2) EAP enabled RADIUS messages 132 over UDP (layer 3 link) 134 in the wired side as shown in the diagram of FIG. 4. The Authenticator 122 will transform the EAPOL messages 128 from the Supplicants 120 into the RADIUS messages 132 and send them to the Authentication Server 124 and vice-versa. To do this, shared confidential information (e.g., a secret identifier) is pre-configured in both the Authenticator 122 and the Authentication Server 124. This “secret identifier”, which is different from the user's “password” discussed above, is used for securing the messages exchanged between the Authenticator 122 and the Authentication Server 124.

For a fixed located Authenticator 122, this task is relative easy to accomplish. For users, the password is associated with the user id. For the Authenticator 122, the secret identifier is associated with the IP address of the Authenticator 122. Sometimes, a mobile AP (Authenticator) will dynamically receive its IP address when the mobile AP joins the network. Therefore, it may not be practical to statically configure within a RADIUS server both the IP address and the associated secret identifier for a mobile Authenticator. However, for a fixed IAP, the IP address can be pre-assigned and therefore the IP address and secret identifier pair can be pre-configured in RADIUS server.

It is also noted that any of the IAPs 106 can be a mobile IAP as described, for example, in U.S. patent application Ser. No. 09/929,030 of Masood Garahi and Peter J. Stanforth entitled “Movable Access Points and Repeaters for Minimizing Coverage and Capacity Constraints in a Wireless Communications Network and a Method for Using the Same”, the entire content of which is incorporated herein by reference. These mobile IAPs communicate with other mobile or fixed IAPs via any suitable backhaul technology, such as microwave.

In a mobile access point network such as a mobile wireless distribution system (WDS), the Access Points are meshed together and form a meshed mobile wireless network. As understood in the art, a wireless meshed network can also be referred to as a wireless ad-hoc peer-to-peer network in which devices or “nodes” can hop through each other to reach other devices in the network as described above with regard to FIG. 1, for example. Since a mobile IAP 106 can still function as an Authenticator even though it is mobile and dynamic, it presents a challenge to configure the secure RADIUS link between the Authenticator and the Authentication Server as mentioned above.

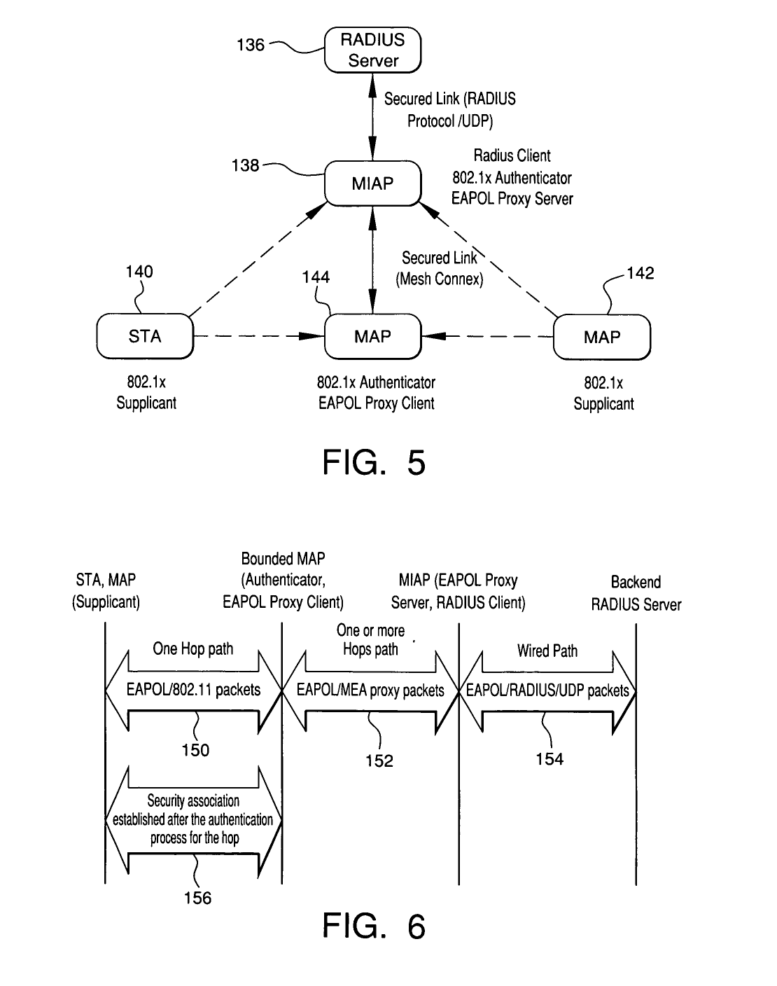

FIG. 5 illustrates an example of a modified authentication framework for WLAN with a meshed WDS. As indicted, the RADIUS server 136 is the Authentication Server 124 (see FIG. 3) and is centrally located on the wired network, such as in the core LAN 104 (see FIG. 1). The Mesh Intelligent Access Point (MIAP) 138, which is a stationary IAP 106 as discussed above with regard to FIG. 1, is connected to the RADIUS Server 136 through a wired link or any other suitable secured link. Thus, the MIAP 138 is a RADIUS client, and the RADIUS server 136 and client have shared confidential information statically configured.

As further shown in FIG. 5, a station STA 140 is the end user device which can be, for example a mobile node 102 as discussed above with regard to FIG. 1 and can access the wired network through either MIAP 138 or a MAP (Meshed Access Point) 142 or 144, which can be a mobile or stationary IAP 106. Before a MAP 142 or 144 can take the authenticator role, it must first authenticate to a MIAP 138 or another authenticated MAP 142 or 144. A MAP 142 or 144 can authenticate directly to the MIAP 138 or another authenticated MAP 142 or 144.

For a STA 140 or a MAP 142 or 144 that is one-hop away from an MIAP 138 to authenticate to an MIAP 138, the standard 802.1× framework can be applied where the Supplicant, Authenticator, RADIUS client and RADIUS server are involved. If a STA wants to authenticate to a MAP or a MAP wants to authenticate to another one-hop away authenticated MAP, a new mechanism, namely, an EAPOL proxy, will be used since a statically provisioned RADIUS client in MAP is not desirable. FIG. 6 is a diagram indicating an example of the exchange of information between devices that occurs during authentication according to an embodiment of the present invention.

For example as shown in FIG. 6, the Authenticator (a mobile IAP in this example) has already authenticated to the MIAP or another authenticated MAP. It has also bounded to the MIAP and a MEA (Mesh Enabled Architecture) route to the MIAP. The route may span one or more MAPs. In accordance with this model, the authentication message path has one more new section when comparing the standard 802.1x framework. The new section is across a secured MEA route.

When a bounded MAP (Authenticator) (e.g. MAP 144) receives an EAPOL message during transmission 150 from a STA 140 or a MAP 142 wishing to be authenticated, the bounded MAP 144 uses an EAPOL proxy client instead of RADIUS client to send the messages to the MIAP in transmission 152. The EAPOL proxy client puts the EAPOL message into the MEA link layer packets instead of RADIUS packets as does the RADIUS Client. The MIAP has an EAPOL proxy server which unpacks the EAPOL messages from the MEA link layer packets. The proxy server then uses a RADIUS client to repack the EAPOL messages onto the RADIUS packets and send to the backend RADIUS Server in transmission 154. As original Supplicant-Authenticator-Authentication Server framework, the authentication messages between the Supplicant 120 and the Authentication Server 124 depend on the authentication protocols used. The security association is between the Supplicant 120 and the bounded MAP 144 is thus established for communications 156.

As can be appreciated from the above, the authentication system and method according to the embodiment of the present invention described herein provides certain advantages, such as it allows for an extended 802.1x framework into mobile Meshed WDS. Furthermore, since a RADIUS client is not required for the authenticator, it will easily meet the auto-configuration requirement for the mobile meshed access points. In addition, the MAP can have faster handoff between two MIAPs. The MAP normally maintains one-hop security associations with all of its neighboring nodes, thus, no new authentication process is needed when the MAP switches to a new MIAP through either the same neighboring node or the different neighboring node.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A method for authenticating a wireless node for access to a communication network through a wireless system, the wireless system including a wired network and a wired access point that is coupled to the wired network and is adapted to enable communication between the wired network and wireless nodes, the method comprising:
establishing a wireless node in the wireless system as an authenticator that is adapted to authenticate other wireless nodes in the network; and
when one of the other wireless nodes attempts to access the communication network, controlling the authenticator wireless node to send authentication information to an authentication server in the network to authenticate that other wireless node for access to the communication network.

2. A method as claimed in claim 1, wherein:
the authenticator wireless node is a mobile wireless node.

3. A method as claimed in claim 1, wherein:
the authenticator wireless node is a wireless access point.

4. A method as claimed in claim 3, wherein:
the wireless access point is mobile.

5. A method as claimed in claim 4, wherein the establishing step comprises:
when the authenticator wireless node is a mobile wireless access point, authenticating the mobile wireless access point with a fixed wireless access point or another already authenticated mobile wireless access point before permitting the authenticator wireless node to send the authentication information to the authentication server in the network to authenticate that other wireless node for access to the communication network.

6. A method as claimed in claim 1, wherein:
the wireless system is an ad-hoc peer-to-peer network.

7. A method as claimed in claim 1, wherein:
the authenticator wireless node sends the authentication information to the authentication server via the wired access point.

8. A method as claimed in claim 7, wherein:
the authenticator wireless node uses an extensible authentication protocol over local area network (EAPOL) proxy to send the authentication information to the wired access point.

9. A method as claimed in claim 1, wherein the establishing step comprises:
storing at the authentication server an IP address and identifier associated with the wireless node being established as an authenticator wireless node when the wireless node being established as an authenticator wireless node is a fixed wireless node.

10. A wireless node, adapted for use in a wireless system, for authenticating another wireless node for access to the wireless system, the wireless system including a wired network and a wired access point that is coupled to the wired network and enables communication between the wired network and other wireless nodes, the wireless node comprising:
a controller, adapted to operate a protocol to establish itself as an authenticator wireless node that is adapted to authenticate other wireless nodes for access to the wireless system, such that when one of the other wireless nodes attempts to access the wireless system, the authenticator wireless node is adapted to send authentication information to an authentication server in the wired network to authenticate that other wireless node for access to the wireless system.

11. A wireless node as claimed in claim 10, wherein:
the authenticator wireless node is a mobile wireless node.

12. A wireless node as claimed in claim 10, wherein:
the authenticator wireless node is a wireless access point.

13. A wireless node as claimed in claim 12, wherein:
the wireless access point is mobile.

14. A wireless node as claimed in claim 10, wherein:
the wireless system is an ad-hoc peer-to-peer network.

15. A wireless node as claimed in claim 10, wherein:
the authenticator wireless node sends the authentication information to the authentication server via the wired access point.

16. A wireless node as claimed in claim 10, wherein:
the protocol includes an extensible authentication protocol over local area network (EAPOL) proxy.

17. A communication network, comprising:
a wired network;
a wired access point that is wired to the wired network and enables communication between the wired network and wireless nodes; and
an authenticator that is adapted to authenticate other wireless nodes in the network for communication in the communication network, such that when one of the other wireless nodes attempts to access the communication network, the authenticator is adapted to send authentication information to an authentication server associated with the wired network to authenticate that other wireless node for access to the communication network.

18. A communication network as claimed in claim 17, wherein:
the authenticator is a wireless node.

19. A communication network as claimed in claim 17, wherein:
the authenticator is a wireless access point.

20. A communication network as claimed in claim 17, wherein:
the wireless access point is mobile.
